(19) United States
(12) Patent Application Publication
(10) Pub. No.: US 2017/0203811 A1
(43) Pub. Date: Jul. 20, 2017

(54) CONVEYANCE WHILE SEATED USING A HOVERBOARD

(71) Applicant: Eliot Germanovsky, North Miami Beach, FL (US)

(72) Inventor: Eliot Germanovsky, North Miami Beach, FL (US)

(21) Appl. No.: 15/410,227

(22) Filed: Jan. 19, 2017

Related U.S. Application Data
(60) Provisional application No. 62/388,098, filed on Jan. 19, 2016.
(60) Provisional application No. 62/389,893, filed on Mar. 14, 2016.
(60) Provisional application No. 62/392,609, filed on Jun. 7, 2016.

(51) Int. Cl. B62K 27/00; B62D 21/09; B60D 1/02; B60D 1/145; B60D 1/48; B62K 13/06; B60N 2/32; B60N 2/015; B60N 3/10; B62D 11/06; B62K 5/01; B62K 5/08; B60P 3/20; B60N 2/30

(52) U.S. Cl. CPC B62K 27/003; B60P 3/20; B62D 21/09; B60D 1/025; B60D 1/145; B60D 1/486; B60N 2/3097; B60N 2/32; B60N 2/015; B60N 3/103; B62D 11/06; B62K 5/01; B62K 5/08; B62K 13/06; B60D 2001/005

(57) ABSTRACT

A cart or conveyance for a person uses a two wheeled electric hoverboard as a drive unit. A clamp is positioned about the center of the hoverboard to enable the hoverboard to be retained by the clamp while remaining rotatable within the clamp. The clamp is hitched to a drawbar, which is in turn connected to an axle supporting two wheels. A seat is attached to the drawbar and axle, and positions a rider to place their feet upon the hoverboard in order to operate the hoverboard.

### CROSS REFERENCE TO RELATED APPLICATIONS

This application claims the benefit of U.S. Provisional Patent Applications No. 62/388,098, filed Jan. 19, 2016; 62/389,893, filed Mar. 14, 2016; and 62/392,609, filed Jun. 7, 2106, the contents of all of which are incorporated herein by reference in their entirety.

### FIELD OF THE DISCLOSURE

The disclosure relates to a system and method for conveying a person using a hoverboard as a drive unit, and in particular, a towed cart enabling a rider to operate the hoverboard using feet only.

### BACKGROUND OF THE DISCLOSURE

A self-balancing scooter, or “hoverboard”, is a battery operated two wheeled device which can carry a person while standing. Two platforms, or foot rests, support the feet of the rider, and a wheel is positioned outboard of each foot rest. Gyroscopes and other sensors within the scooter, connected to an internal computer, help to maintain the balance of the rider, by rotating the wheels independently to compensate for instability.

### SUMMARY OF THE DISCLOSURE

In an embodiment of the disclosure, a device for conveying a person using a two wheeled electric hoverboard, comprises a clamp forming an interior dimension, the clamp positionable about a center portion of the hoverboard to enable the hoverboard to be retained by the clamp and to be rotatable within the clamp; a clamp hitch portion connected to the clamp; a drawbar; a drawbar hitch portion mateable with the clamp hitch portion to pivotally couple the drawbar to the clamp; one or more axles connected to the drawbar; at least two wheels connected to the one or more axles; and a seat affixable in connection to the drawbar and axle, the seat oriented to enable the person to sit on the seat and place both feet on the hoverboard in order to operate the hoverboard.

In variations thereof, the seat is a folding beach chair; the seat is a portable cooler; the clamp hitch portion is a threaded post, and the drawbar hitch portion is an aperture and a threaded fastener; the drawbar includes a plurality of spaced apart apertures selectable for insertion of the threaded post; the device further includes a frame connectable to the one or more axles and the drawbar; and/or the device is driveable using the feet of the person, without a requirement to use hands of the person.

In other variations thereof, the clamp is formed as a strap having hook and loop fasteners; the clamp is formed of two semicircular halves joined by a hinge, and mutually engageable with a latch; the drawbar is releaseably connectable to the one or more axles; the device further includes a vertical post connected to the drawbar proximate a forward portion of the device, the vertical post supporting handlebars; the post is pivotably latched to the drawbar to be foldable to a non-vertical storage orientation; the seat is connected to a vertical post proximate the one or more axles at a rearward portion of the device; and/or the device further includes an external battery connectable as a power source to the hoverboard.

In another embodiment of the disclosure, a device for conveying a person comprises an electric two wheeled drive unit having a foot rest for each of two feet positioned inboard of the two wheels, the drive unit operable by placing the feet of the person on the foot rest and tilting the ankles and feet to tilt the foot rests, whereby tilting forward causes a forward rotation of the wheels, and tilting backward causes a rearward rotation of the wheels, and whereby pivoting the drive unit by pushing one foot rest forward relative to the other causes steering of the drive unit; a clamp forming an interior dimension, the clamp positionable about a center portion of the drive unit to enable the drive unit to be retained by the clamp and to be rotatable within the clamp to be tiltable; a clamp hitch portion connected to the clamp; a drawbar; a drawbar hitch portion mateable with the clamp hitch portion to pivotally couple the drawbar to the clamp; one or more axles connected to the drawbar; at least two wheels connected to the one or more axles; and a seat affixable in connection to the drawbar and axle, the seat oriented to enable the person to sit on the seat and place both feet on the foot rests in order to operate the drive unit to tow and move the device and seated person.

In variations thereof, the seat is at least one of a folding beach chair, picnic cooler, bicycle seat; the clamp hitch portion is a threaded post, and the drawbar hitch portion is an aperture and a threaded fastener; the device further includes a frame connectable to the one or more axles and the drawbar; and/or the clamp is formed of two semicircular halves joined by a hinge, and mutually engageable with a latch.

In another embodiment of the disclosure, a method of conveying a person comprises clamping an electric two wheeled drive unit with a clamp forming an interior dimension, the clamp positionable about a center portion of the drive unit to enable the drive unit to be retained by the clamp and to be rotatable within the clamp to be tiltable, the drive unit having a foot rest for each of two feet positioned inboard of the two wheels, the drive unit operable by placing the feet of the person on the foot rest and tilting the ankles and feet to tilt the foot rests, whereby tilting forward causes a forward rotation of the wheels, and tilting backward causes a rearward rotation of the wheels, and whereby pivoting the drive unit by pushing one foot rest forward relative to the other causes steering of the drive unit; hitching the clamp to a drawbar to pivotally couple the drawbar to the clamp, the drawbar connected to one or more axles rotatably supporting at least two wheels; and seating upon a seat affixed to the drawbar and axle, the seat oriented to enable the person to sit on the seat and place both feet on the foot rests in order to operate the drive unit by tilting and pivoting the drive unit to tow the device and seated person.

### BRIEF DESCRIPTION OF THE DRAWINGS

A more complete understanding of the present disclosure, and the attendant advantages and features thereof, will be more readily understood by reference to the following detailed description when considered in conjunction with the accompanying drawings wherein:

FIG. 1 is a perspective view of a cart of the disclosure including a hoverboard drive unit;

FIG. 2 is a hoverboard configured with a clamp of the disclosure;

FIG. 3 is a detail view of a clamp of the disclosure formed as a strap and an integrated post;

FIG. 4 is a perspective view of a hinged clamp of the disclosure;

FIG. 5 is an alternative view of the clamp of FIG. 4;

FIG. 5A is a perspective view of an alternative hitch of the disclosure;

FIG. 6 is a perspective view of a cart of the disclosure including a frame base, the clamp of FIG. 5, and a fastener knob;

FIG. 7 is a perspective view of the cart of FIG. 1, including a seat formed by a picnic cooler, and including a drawbar extension of the disclosure;

FIG. 8 is a perspective view of a cart of the disclosure including a bicycle seat, handlebars connected to the drawbar, and the clamp of FIG. 5 securing a hoverboard drive unit;

FIG. 9 is a perspective view of a cart of the disclosure illustrating handlebars operatively affixed to foot rests of the hoverboard drive unit;

FIG. 10 is a perspective view of a cart of the disclosure hitched to a SEGUE style scooter, the cart including a forward caster wheel, the scooter including a modified control handle; and

FIG. 11 is a perspective view of a cart of the disclosure that is disassembleable into small components which are easily carried by a person, the cart including an external battery.

### DETAILED DESCRIPTION OF THE DISCLOSURE

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting, but merely as a basis for the claims and as a representative basis for teaching one skilled in the art to variously employ the present subject matter in virtually any appropriately detailed structure and function. Further, the terms and phrases used herein are not intended to be limiting, but rather, to provide an understandable description of the concepts.

The terms “a” or “an”, as used herein, are defined as one or more than one. The term plurality, as used herein, is defined as two or more than two. The term another, as used herein, is defined as at least a second or more. The terms “including” and “having,” as used herein, are defined as comprising (i.e., open language). The term “coupled,” as used herein, is defined as “connected,” although not necessarily directly, and not necessarily mechanically.

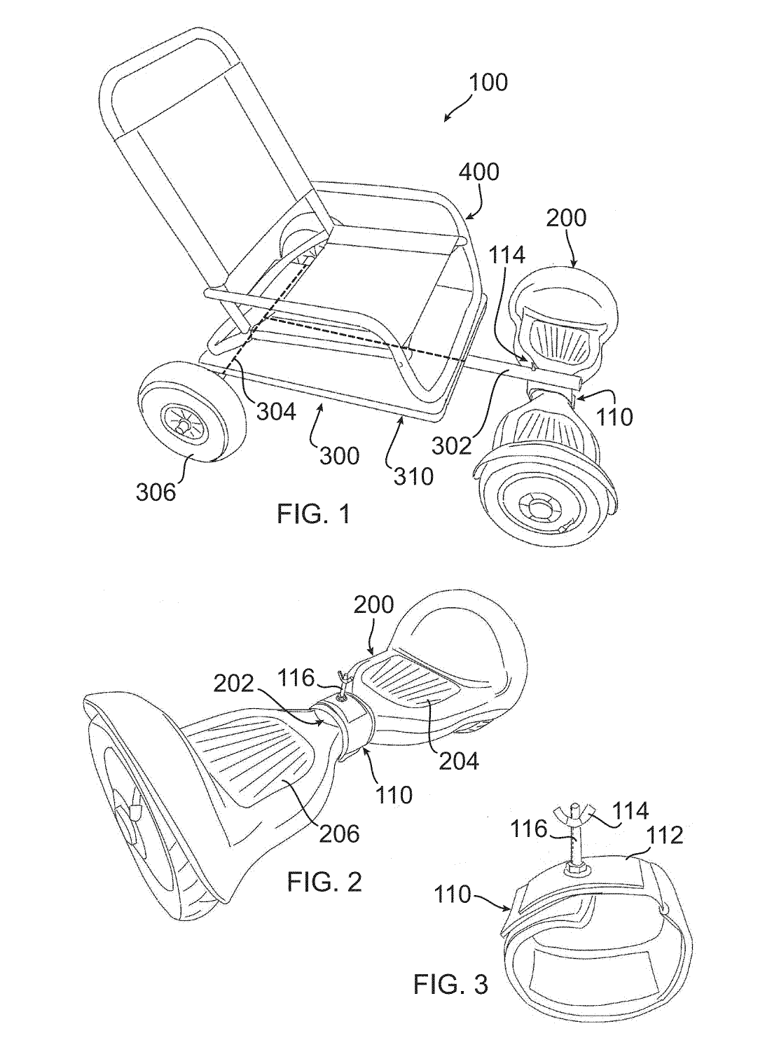

With reference to FIGS. 1-3, an electric cart 100 of the disclosure includes an off-the-shelf commercially available stand-up “hoverboard”, or board 200, designed for stand-up operation, a wheeled frame 300, and a clamp 110 which couples frame 300 to board 200. A lightweight chair 400 is positioned upon frame 300.

In the embodiment of FIGS. 1-3, clamp 110 has the form of a strap which includes mating hook and loop fastener portions, for example VELCRO, at opposed sides of opposite ends of the clamp, enabling the clamp to form a releasably securable closed loop. Clamp 110 is fabricated with a material that is strong and flexible, and which has a limited ability to stretch, such as polymeric webbing. Clamp 110 can further include an inner layer of soft, non-scuff material, such as high density neoprene, to protect surfaces of board 200 when clamp 110 surrounds board 200, as illustrated and described herein.

The disclosure can be implemented with any of the various known embodiments of board 200 which include a narrowed and rounded portion 202 at the center of the board, located between footrests 204, 206. Examples of such boards include the SWAGWAY X2, T1, T3, or T5; HOVERZON XLS; POWERBOARD; or RAZOR HOVERTRAX, although others may be hereinafter introduced. The narrowed portion must capable of being encircled by clamp 110 without interfering with controls of the board, and must enable to board to rotate within the cuff during use.

While the clamps described herein exploit the narrowed and rounded portion 202 of the foregoing boards, it is nonetheless possible to connect to boards which are not regularly shaped or sufficiently narrow for a provided clamp 110. Specifically, in one option, a rubber plumbing pipe joint can be affixed to the board using band clamps. A hole can be drilled through the pipe joint and bolt 216 can be passed therethrough to attach drawbar 302. In another option, a surfboard style neoprene cuff can be used as the basis of a clamp, and can also be drilled to support bolt 216. In a still further option, a specific clamp can be fabricated to bit each popular type of board 200 which has a unique center shape.

As shown in FIGS. 2 and 3, clamp 110 is provided with a threaded bolt 116 and a threaded fastener 114. A reinforcing plate 112 can be provided to prevent bolt 116 from pulling through fabric of clamp 110; to provide a wear surface for contact with frame 300; and/or to otherwise provide additional strength. Fastener 114 has the form of a wing nut or knurled knob which can be used to attach clamp 110 to frame 300 without requiring the use of tools.

Frame 300 includes a drawbar 302 and an axle 304. Axle 304 can extend completely between wheels 306, as illustrated by a dashed line in FIG. 1, or may be provided as a separate axle component for each wheel, each axle component attached to a frame base 310. Frame base 310 has the form of a sheet surface in FIG. 1, but may have other forms to suit various other purposes, as described elsewhere herein. Wheels or axle may be provided with ball-bearing, plain bearing, or other bearing style, selected based upon cost, environment, and expected weight or other anticipated burdens to the bearing surfaces.

To assemble cart 100, draw bar is connected to bolt 116 by passing bolt 116 through an aperture 312 (shown in FIG. 6) in drawbar 302, to hitch cart 100 to board 200. Threaded fastener 114 is then attached to pivotably secure drawbar 302 to clamp 110, and thereby to board 200. In the embodiment of FIG. 1, chair 400 is affixed to frame base 310 by any known means, including clamps, clips, screws, or any other known means. Advantageously, chair 400 is releaseably attached to frame base 310, whereby chair 400 can be folded and stowed, or deployed elsewhere, when cart 100 is not in use. Non-stretching straps with hook and loop fasteners can be used to secure chair 400 to frame 300, for example by encircling a frame of chair 400 and frame base 310 by the hook and loop fastener, pulling tight, and engaging the hook and loop fasteners. It is important that the fastener has a limited resilience in order to maintain a position of chair 400 with respect to frame 300. Bolt 116 is threaded in the embodiment shown, however bolt 116 can be provided with any form of fastener at a distal end whereby drawbar 302 can be retained upon bolt 116.

In an alternative hitch embodiment, drawbar 302 includes a post or pin 348 which is latched into a socket 350 attached to clamp 110 in the manner of a 5^{th} wheel hitch, as shown in FIG. 5A. Other variations on coupling drawbar 302 to clamp 110/110A would be apparent to one skilled in the art, where board 200 can be pivoted side to side for steering, while being rotated within clamp 110/110A.

To use cart 100, the rider sits upon chair 400, and places their feet upon footpads 204, 206 to cover pressure pads thereunder. Board 200 is otherwise manipulated to cause wheel rotation in the usual manner; specifically, a forward tilt of the foot pads to begin forward movement, a rearward tilt for rearward movement, and extending one foot or the other forwards to initiate a change of direction. When steering, board 200 pivots about bolt 116. When tilting, board 200 rotates within clamp 110. As board 200 self-propels forward in response to the rider's foot position, drawbar 302 is pulled, and the remainder of cart 100, connected to drawbar 302, is thereby towed by board 200.

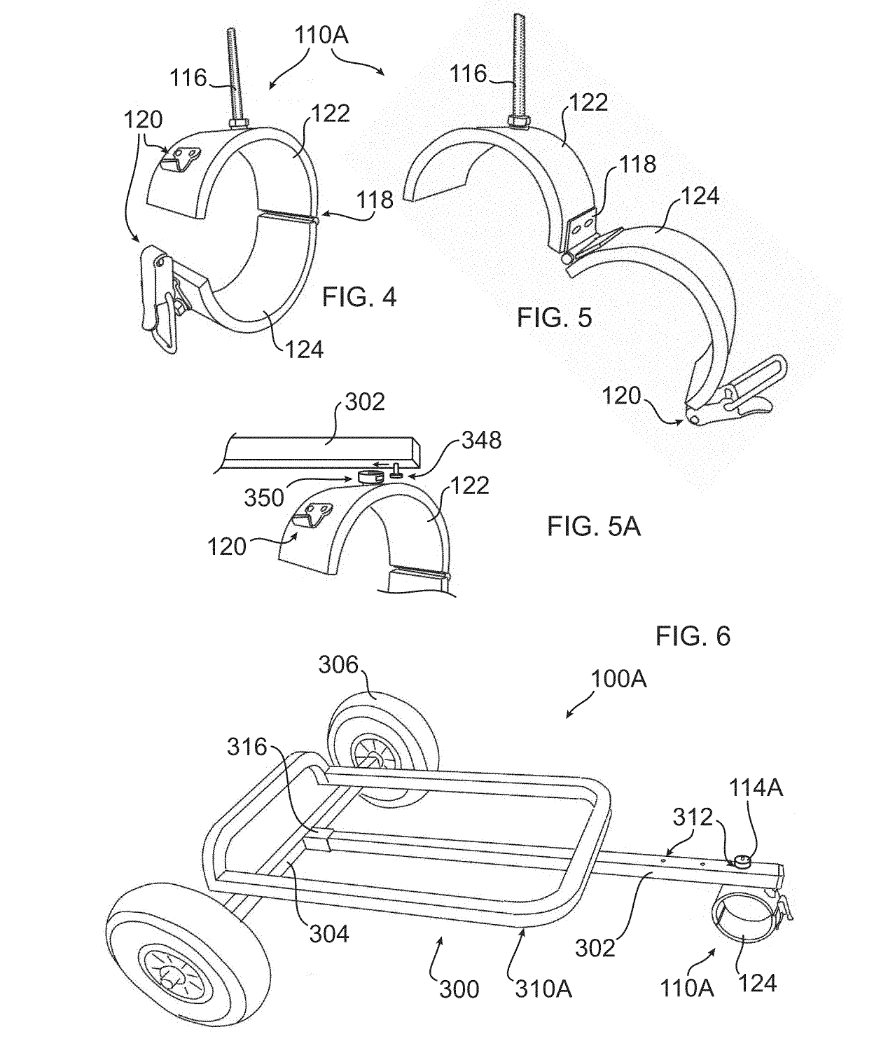

In FIGS. 4-5, an alternative clamp 110A is shown, in which two rigid semicircular clamp halves 122, 124 are mutually connected by a hinge 118, and a releaseable latch 120. Clamp 110A can be quickly and easily attached to board 200 at the same location for use in the same manner as described with respect to clamp 110, however instead of wrapping a strap about a center of board at narrowed portion 202, clamp 110A can be hinged shut over narrowed portion 202 and latched shut, producing a relatively stronger and more quickly realized engagement. As shown in FIG. 6, a knob 114A can be threaded over an end of bolt 206 which has been passed through a selected aperture 312 of drawbar 302. By providing apertures 312 spaced along drawbar 302, it may be possible to adjust a maximum tongue weight imposed upon board 200, to meet weight requirements; impact traction of board 200; and/or to change handling characteristics of cart 100.

Frame 300A includes a U-shaped frame base 310A which rests upon drawbar 302 and axle 304. An upright portion 314 extends from base 310A, and can be used to prevent loads from sliding rearwards and out of engagement with frame 300. In FIG. 6, drawbar 302 inserts into a bracket 316, although frame portions may be interconnected by any known means, including bolts, clips, clamps, welding, brazing, soldering, adhesive, threaded connection, interference fit, or any other known or hereinafter developed method. Frame 300/300A can be made using any materials of suitable strength, corrosion resistance, and cost, including plastic, carbon fiber, or metal. Aluminum is advantageous as it has a relatively low cost compared to carbon fiber and some other lightweight metals, enables a low assembled weight, and offers good strength.

In FIG. 7, a cargo bin 320, in this example a picnic cooler, has been mounted upon frame base 310. As cargo bin 320 is sized to be mounted longitudinally along frame base 310, a drawbar extension 302A has been connected to an end of drawbar 302 to provide for a longer cart 100 length. In this example, drawbar extension 302A inserts into an end of drawbar 302, and a through-bolt 322 interconnects the mated parts 302, 302A. Other forms of interconnection can be used, however, including a threaded connection. Cargo bin 320 includes a lid 324 which is selected to be sufficiently strong to be sat upon, whereby cargo bin forms a seat for a rider while operating board 200 as described elsewhere herein.

FIG. 7 additionally depicts a T-handle 326 which may be inserted into an end of drawbar 302 or drawbar extension 302A to enable hand pulling of cart 100 when desired or necessary. T-handle 326 may be connected by threads, a quick-connect coupling, or any other known means. In another embodiment, T-handle 326 is affixed to drawbar 302 or drawbar extension 302A. When hand pulling cart 100, board 200 may be stowed within or upon cargo bin 320 for an improved distribution of weight. Cargo bin 320 is advantageously releaseably attached to frame 300, for example using through-bolts and wingnuts (not shown), straps, or any other method.

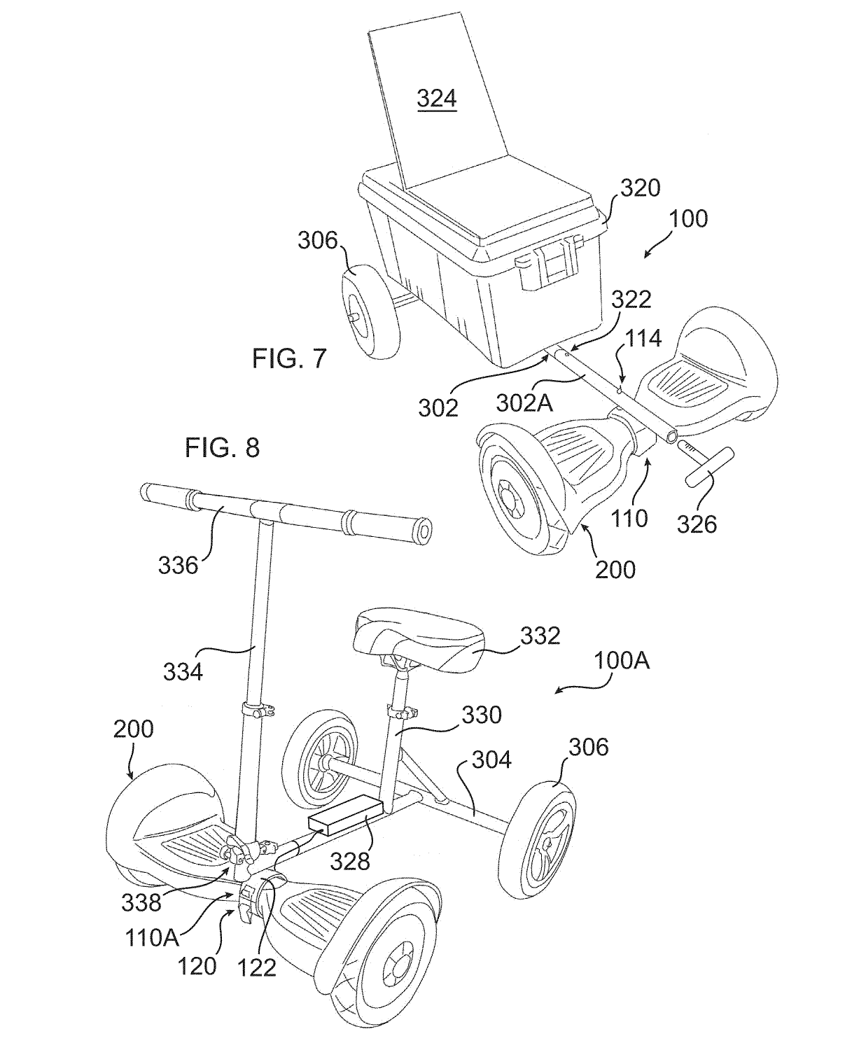

As shown in FIG. 8, in an embodiment, one or more external batteries 328, for example a battery produced for an electric bicycle, or any other type of energy efficient battery, can be stored upon frame 300 or within or upon cargo bin 320. The external battery can be connected to board 200 when needed, for example when batteries within board 200 become depleted, or may be provided to augment battery power of board 200. Extra external batteries 328 may be stored upon cart 100, and be connected as needed to increase the range of cart 100. Such extra external batteries 328 can alternatively be made available along the route, so that they can be exchanged with an in-use but soon depleted external battery 328 as needed. External batteries 328 may be attached at other locations than the location illustrated, as space permits. Clips, housings, brackets, or other fixtures may be provided as desired to provide for releasable mechanical and electrical connection of external batteries 328, as would be understood within the art, including providing external batteries within frame 300.

With further reference to FIG. 8, cart 100 provides, instead of or in addition to a cargo bin 320, a rearward vertical telescoping post 330 is connected to frame 300, upon which is mounted a bicycle seat 332. Similarly, a forward vertical telescoping post 334 is connected to an end of drawbar 302, upon which are mounted handlebars 336. Posts 330, 334 can be attached to frame 300 by welding, bracing, threaded connection, pivotable connection, or any other manner. A rider operates cart 100 as otherwise described herein, sitting on bicycle seat 332 and using the feet to control board 200. Handlebars 336 are provided for the stability of the rider, and do not cause turning of cart 100. As can be seen at a lower portion of forward telescoping post 334, a pivoting clamp connection 338 may be loosened in order to lower forward vertical telescoping post to render cart 100 more compact for storage and/or transportation to a use site.

In an embodiment, a plurality of carts 100 can be connected one to the other, with only a single board 200 at the leading cart. Trailing carts can connect to the preceding cart using any type of pivotable hitch, such as a carabiner, aircraft joint, bolt 116 provided at a trailing edge of the leading cart, resilient fastener, or other known fastener. In an embodiment, a cart 100 is positioned under the center of an elongate object, such as a kayak, and a forward end of the elongate object is attached to the towing cart 100. In such embodiments, drawbar 302 can be removed.

Accordingly, the disclosure provides for a cart 100 which can be operated by a rider using the feet only, without a requirement of the use of hands for steering or any other control. Cart 100 can be provided, stored, or transported in a partly disassembled state in order to be more compact. Frame 300 or 300A provides a flexible platform upon which can be placed any variety of objects, including a seat for a driven cart, or a storage bin or seat for towed carts, or a combined storage bin and seat. The size of cart 100 is dependent upon its expected use. However, a cart of sufficient size to support a rider, for example, has a collapsed shipping size of is 31 inches×15 inches×4 inches, with a shipping weight of 11.6 lbs.

Cart 100 can be used on or off-road, and can ride over grass, gravel, and packed sand. A wheel size of board 200 and cart 100 is advantageously selected to facilitate rolling upon a particular surface, with larger board wheels, for example 10 inch wheels, favoring soft surfaces. Softer or less-inflated wheels can provide improved traction, but use more energy to turn, and therefore deplete batteries more quickly than firm or more highly inflated tires. Cart 100 can be provided with similar sized wheels relative to board 200, or can be provided with smaller or larger wheels.

In addition to paved or off-road surfaces, cart 100 can be used, for example, in supermarkets or other locations where extensive walking is otherwise required, but would be tiring, difficult, or impossible for some individuals. Cart 100 further provides additional safety, as the likelihood of falling off due to imbalance or striking an impediment are greatly reduced. A helmet, as well as hand, elbow, and knee protection can provide further safety in the event the rider falls from cart 100.

In a further embodiment, board 200 is calibrated using a built-in interface of the board to orient the footrests at an angle facing towards a seat of cart 100, as opposed to planar with respect to the Earth. In one example, board 200 is tilted in the direction of the rider, and the power button is pressed for 2-4 minutes, until a beep is heard or indicator lights illuminate or blink. Next, board 200 is turned off and back on, at which point it will be programmed for a normally tilted orientation. It is typically important not to touch the pressure pads on footrests 204, 206 while recalibrating, as this could damage the sensors.

This enables a more comfortable resting position for the feet when seated. If such calibration cannot be achieved, angular foam blocks can be placed upon footrests 204, 206 to achieve the desired foot position. Additionally, photosensors which detect the presence of feet can be covered to cause the hoverboard to remain in a ‘ready’ state.

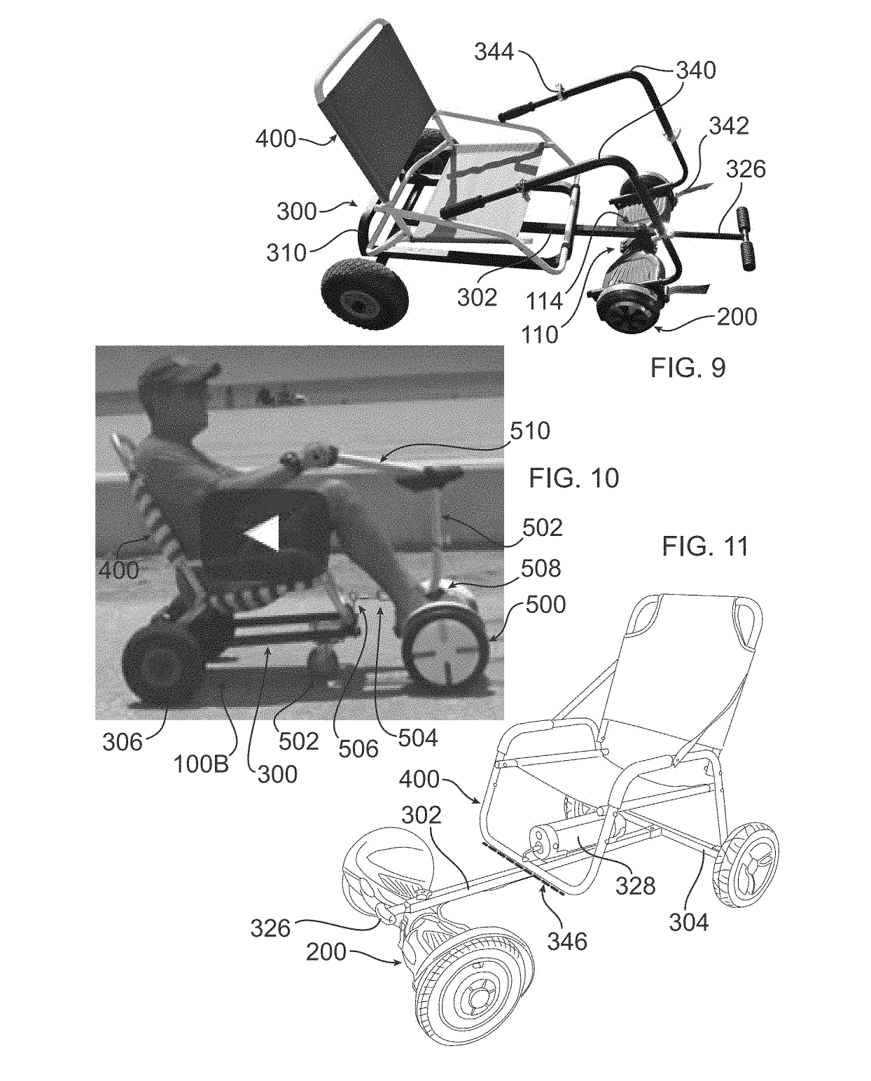

In FIG. 9, it may be seen that handles 340 can be used, together with the disclosure, to case a tilting or rotation of board 200, in order to operate board 200. Handles 340 can be provided for enjoyment, or if foot motion is a problem. As shown in FIG. 9, each of handle 340 is secured by a handle strap 342 which passes around an exterior of board 200 at the location of each of footrest 204, 206. Handles may have the shape shown, or a different shape, however extend toward the rider when the rider is seated upon cart 100. As further shown in FIG. 9, each of handles 340 can be provided with telescoping vertical and horizontal sections secured by clamps 344, enabling a height and reach to the handles to be adjusted for the comfort of the rider.

The disclosure can further be carried out using a SEGWAY brand or style of scooter 500, which uses an upright post 502 for support and steering. In this embodiment, illustrated in FIG. 10, the upright post 502 of scooter 500 has been shortened, and scooter 500 is connected to cart 100B with a carabiner or other flexible coupling 504. A hook eye 506 can be attached to frame 300 to facilitate connection to the carabiner. At the Segue, a larger carabiner or yoke 508 can be secured about the base of upright post 502, and is connectable to coupling 504. A caster wheel 502 is provided at a forward end of frame 300, so that the Segue is not supporting the weight of the rider. A handlebar extension 510 is connected to the top of the control post, and extends back to the rider, who exercises control otherwise in the manner known for the scooter 500.

With reference to FIG. 11, in another embodiment of the disclosure, cart 100 disassembles into smaller parts which can be stowed in a carry bag and placed into a case or storage area, such as a car trunk. Chair 400 is removed and folded, as originally designed. Chair 400 can be attached to frame 300 with hook and loop fastener straps for this purpose. Additionally, drawbar 302 is detached at bracket 316, and any frame base 310, if present, is removed from axle 304. The resultant parts are lightweight, not bulky, and can be stored for later reassembly. In FIG. 11, there is no frame base 310, and chair is releaseably affixable to axle 304 and drawbar 302. In other embodiments, a stabilizing cross-piece 346, shown in dashed lines, can further be removed, for example unbolted or clamped from drawbar 302, to reduce bulk. Wheels 306 can further be removed by removing a pin or other fastener, resulting in a stowed dimension of 35×10×6 inches.

In a typical assembly of the cart of FIG. 1, for example, axle 304 is bolted to frame base 310, either by inserting bolts into threaded holes, or by using through-bolts. Drawbar 302 is inserted into bracket 316 and secured with a bolt, and is bolted to a leading edge of frame base 310. Wheels 306 are slid onto axle 304 and secured with spring pins. Clamp 110 or 110A is connected to board 200 and secured or latched, so that it firmly connected but able to be rotated about narrowed portion 202. Bolt 116 is passed through aperture 312 of drawbar 302, and secured with a wing-nut or knob.

Typical boards 200 can support a weight of 230 pounds. Greater weights can be towed by board 200, however, as cart 100 distributes the weight load over one or more additional axles.

The disclosure thus provides a new and useful purpose for a hoverboard, which is principally intended to be used as a toy or amusement device, and which cannot be used by many adults or individuals with limited balance, or who are particularly vulnerable to injury due to falls. With the disclosure, such individuals can be safely seated while being conveyed by the hoverboard. As such the disclosure provides either or both of a fun conveyance, and a much needed transportation alternative. More particularly, the disclosure provides a wheelchair for the mobility impaired, with a weight of less than 20 pounds, and at a cost as low as about $200.

All references cited herein are expressly incorporated by reference in their entirety. It will be appreciated by persons skilled in the art that the present disclosure is not limited to what has been particularly shown and described herein above. In addition, unless mention was made above to the contrary, it should be noted that all of the accompanying drawings are not to scale. There are many different features to the present disclosure and it is contemplated that these features may be used together or separately. Thus, the disclosure should not be limited to any particular combination of features or to a particular application of the disclosure. Further, it should be understood that variations and modifications within the spirit and scope of the disclosure might occur to those skilled in the art to which the disclosure pertains. Accordingly, all expedient modifications readily attainable by one versed in the art from the disclosure set forth herein that are within the scope and spirit of the present disclosure are to be included as further embodiments of the present disclosure.

What is claimed is:

1. A device for conveying a person using a two wheeled electric hoverboard, comprising:
a clamp forming an interior dimension, the clamp positionable about a center portion of the hoverboard to enable the hoverboard to be retained by the clamp and to be rotatable within the clamp;
a clamp hitch portion connected to the clamp;
a drawbar;
a drawbar hitch portion mateable with the clamp hitch portion to pivotally couple the drawbar to the clamp;
one or more axles connected to the drawbar;
at least two wheels connected to the one or more axles; and
a seat affixable in connection to the drawbar and axle, the seat oriented to enable the person to sit on the seat and place both feet on the hoverboard in order to operate the hoverboard.

2. The device of claim 1, wherein the seat is a folding beach chair.

3. The device of claim 1, wherein the seat is a portable cooler.

4. The device of claim 1, wherein the clamp hitch portion is a threaded post, and the drawbar hitch portion is an aperture and a threaded fastener.

5. The device of claim 4, wherein the drawbar includes a plurality of spaced apart apertures selectable for insertion of the threaded post.

6. The device of claim 1, further including a frame connectable to the one or more axles and the drawbar.

7. The device of claim 1, wherein the device is driveable using the feet of the person, without a requirement to use hands of the person.

8. The device of claim 1, wherein the clamp is formed as a strap having hook and loop fasteners.

9. The device of claim 1, wherein the clamp is formed of two semicircular halves joined by a hinge, and mutually engageable with a latch.

10. The device of claim 1, wherein the drawbar is releaseably connectable to the one or more axles.

11. The device of claim 1, further including a vertical post connected to the drawbar proximate a forward portion of the device, the vertical post supporting handlebars.

12. The device of claim 11, the post pivotably latched to the drawbar to be foldable to a non-vertical storage orientation.

13. The device of claim 11, the seat connected to a vertical post proximate the one or more axles at a rearward portion of the device.

14. The device of claim 1, further including an external battery connectable as a power source to the hoverboard.

15. A device for conveying a person, comprising:
an electric two wheeled drive unit having a foot rest for each of two feet positioned inboard of the two wheels, the drive unit operable by placing the feet of the person on the foot rest and tilting the ankles and feet to tilt the foot rests, whereby tilting forward causes a forward rotation of the wheels, and tilting backward causes a rearward rotation of the wheels, and whereby pivoting the drive unit by pushing one foot rest forward relative to the other causes steering of the drive unit;
a clamp forming an interior dimension, the clamp positionable about a center portion of the drive unit to enable the drive unit to be retained by the clamp and to be rotatable within the clamp to be tiltable;
a clamp hitch portion connected to the clamp;
a drawbar;
a drawbar hitch portion mateable with the clamp hitch portion to pivotally couple the drawbar to the clamp;
one or more axles connected to the drawbar;
at least two wheels connected to the one or more axles; and
a seat affixable in connection to the drawbar and axle, the seat oriented to enable the person to sit on the seat and place both feet on the foot rests in order to operate the drive unit to tow and move the device and seated person.

16. The device of claim 15, wherein the seat is at least one of a folding beach chair, picnic cooler, bicycle seat.

17. The device of claim 15, wherein the clamp hitch portion is a threaded post, and the drawbar hitch portion is an aperture and a threaded fastener.

18. The device of claim 15, further including a frame connectable to the one or more axles and the drawbar.

19. The device of claim 15, wherein the clamp is formed of two semicircular halves joined by a hinge, and mutually engageable with a latch.

20. A method of conveying a person, comprising:
clamping an electric two wheeled drive unit with a clamp forming an interior dimension, the clamp positionable about a center portion of the drive unit to enable the drive unit to be retained by the clamp and to be rotatable within the clamp to be tiltable, the drive unit having a foot rest for each of two feet positioned inboard of the two wheels, the drive unit operable by placing the feet of the person on the foot rest and tilting the ankles and feet to tilt the foot rests, whereby tilting forward causes a forward rotation of the wheels, and tilting backward causes a rearward rotation of the wheels, and whereby pivoting the drive unit by pushing one foot rest forward relative to the other causes steering of the drive unit;
hitching the clamp to a drawbar to pivotally couple the drawbar to the clamp, the drawbar connected to one or more axles rotatably supporting at least two wheels; and
seating upon a seat affixed to the drawbar and axle, the seat oriented to enable the person to sit on the seat and place both feet on the foot rests in order to operate the drive unit by tilting and pivoting the drive unit to tow the device and seated person.
